(19) United States
(12) Patent Application Publication
(10) Pub. No.: US 2010/0018020 A1
(43) Pub. Date: Jan. 28, 2010

(54) Method for Manufacturing Micro-Hinge Used in Electric Devices

(76) Inventor: Kuo-Hua Huang, Taipei County (TW)

Correspondence Address: SHOU - HSIN YIN, P.O. BOX 90-3 Taipei, TAIPEI City, 10699, TW

(21) Appl. No.: 12/574,792

(22) Filed: Oct. 7, 2009

Related U.S. Application Data
(63) Continuation-in-part of application No. 11/448,655, filed on Jun. 8, 2006.

(51) Int. Cl. B21D 53/40; E05D 11/08; B23P 11/00

(52) U.S. Cl. 29/11; 16/342; 29/434

(57) ABSTRACT

A method for manufacturing a micro-hinge pivoting two pieces of an electric device is disclosed. The method includes the steps of: a) forming a shaft having a mounting end and a rotating portion and a round block between the mounting end and rotating portion; b) forming a sleeve having a slot and an inner diameter slightly smaller than an outer diameter of the rotating portion; c) providing a connecting element having an connecting end and an extending end; d) combining the connecting end and sleeve; and e) inserting the rotating portion into the sleeve.

The present invention is a continuation-in-part of U.S. patent application Ser. No. 11/448,655 filed on Jun. 8, 2006.

### BACKGROUND OF THE INVENTION

1. Technical Field

The invention relates to pivoting mechanisms for openable devices.

2. Related Art

Many electric devices, such as laptop computers, LCDs, cellular phones and electronic dictionaries, use pivots to make two pieces openable or rotary. USPAP 2003/0126719 discloses a typical prior art shown in FIGS. 1 and 2. '719 is composed of a shaft 1 and a sleeve 2. The shaft 1 is provided with a mounting end 11, a hole 12, a disk 13, a protruding block 14, a shaft rod 15 and an oil groove 16. The shaft 2 is provided with a supporting end 11, a through hole 12, a shaft hole 23, a first and second elastic portion 24, 25 with respective open edges 241, 251, a first and second slot 26, 27, a limiting trough 28 and an inner surface 29. In the manufacturing process, the sleeve 2 is formed into a flat plate first, and then is bent into a hollow cylinder. According to the section along lines 3-3 and 4-4, the first and second open edge 241, 251 still have elasticity for rotarily sheathing the shaft rod 15 in the shaft hole 23. On the other hand, both the protruding block 14 and limiting trough 28 limit a rotary range of the shaft 1. The sleeve 2 is formed by bending, so its accuracy is not good enough to generate consistent damping to the shaft 1. In other words, the shaft 1 sheathed in the sleeve 2 may rotate tightly or unfixedly. And the elasticity fatigue of the sleeve 2 occurs easily. The quality and durability are insufficient.

### SUMMARY OF THE INVENTION

A primary object of the invention is to provide a method for manufacturing a micro-hinge, which simplifies procedure and improves accuracy in an aspect of manufacture and provides consistent damping, smooth rotation and good durability in an aspect of use.

Another object of the invention is to provide various matching for the shaft and sleeve by simple adjustment.

To accomplish the above objects, the method of the invention includes the steps of:

a) forming a shaft having a mounting end and a rotating portion, and a round block between the mounting end and rotating portion;

b) forming a sleeve having a slot and an inner diameter slightly smaller than an outer diameter of the rotating portion;

c) providing a connecting element having an connecting end and an extending end;

d) combining the connecting end and sleeve; and

e) inserting the rotating portion into the sleeve.

### BRIEF DESCRIPTION OF THE DRAWINGS

FIG. 1 is an exploded view of USPAP 2003/0126719;

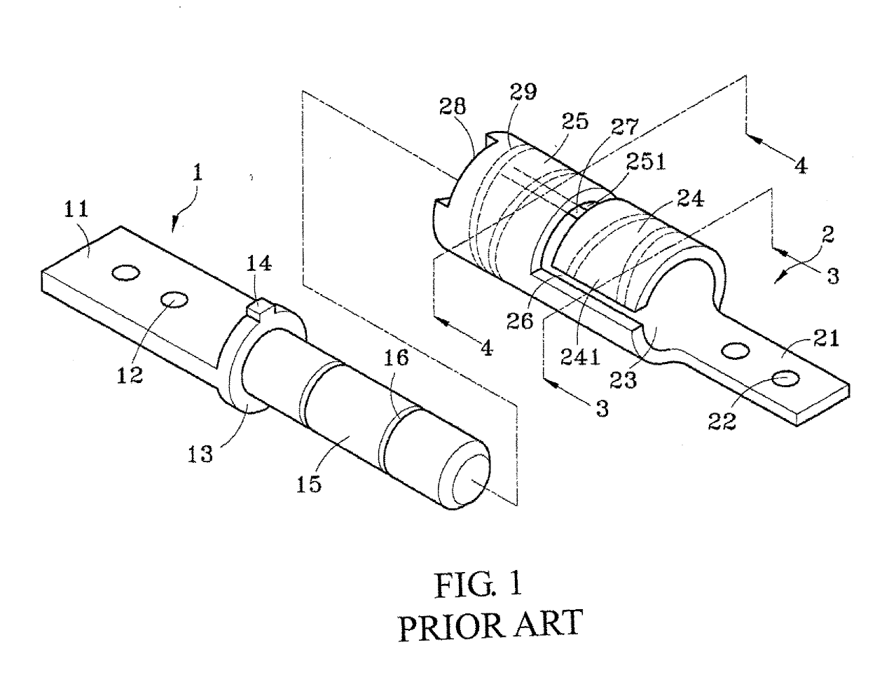

FIG. 2 is a planar view of the sleeve of USPAP 2003/0126719;

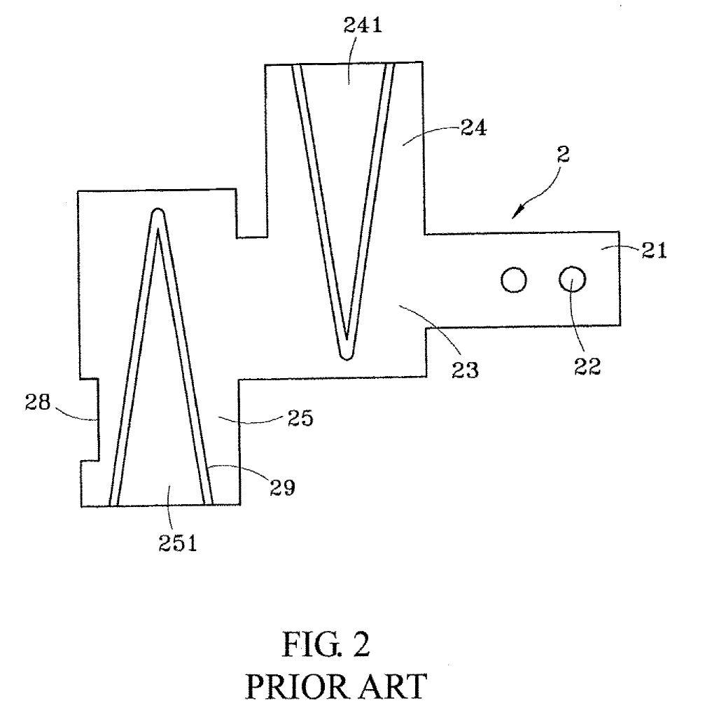

FIG. 3 shows a process of the first embodiment of the invention;

FIG. 4 shows how the first embodiment is used in an electric device;

FIG. 5 shows a process of the second embodiment of the invention;

FIG. 6 shows a process of the third embodiment of the invention;

FIG. 7 shows a process of the fourth embodiment of the invention; and

FIG. 8 shows how the fourth embodiment is used in an electric device.

### DETAILED DESCRIPTION OF THE INVENTION

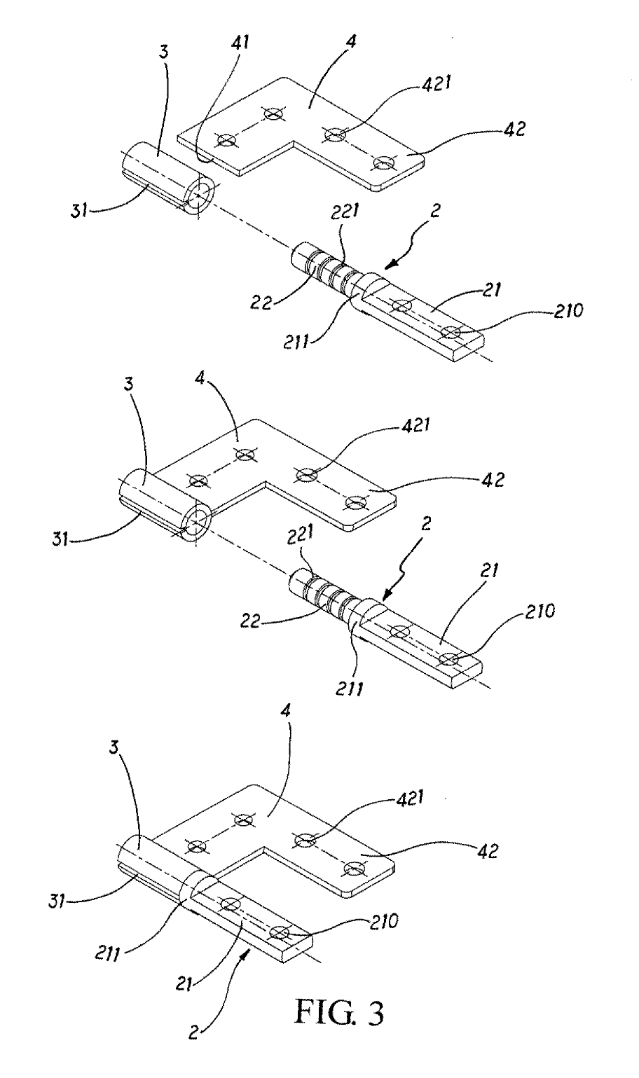

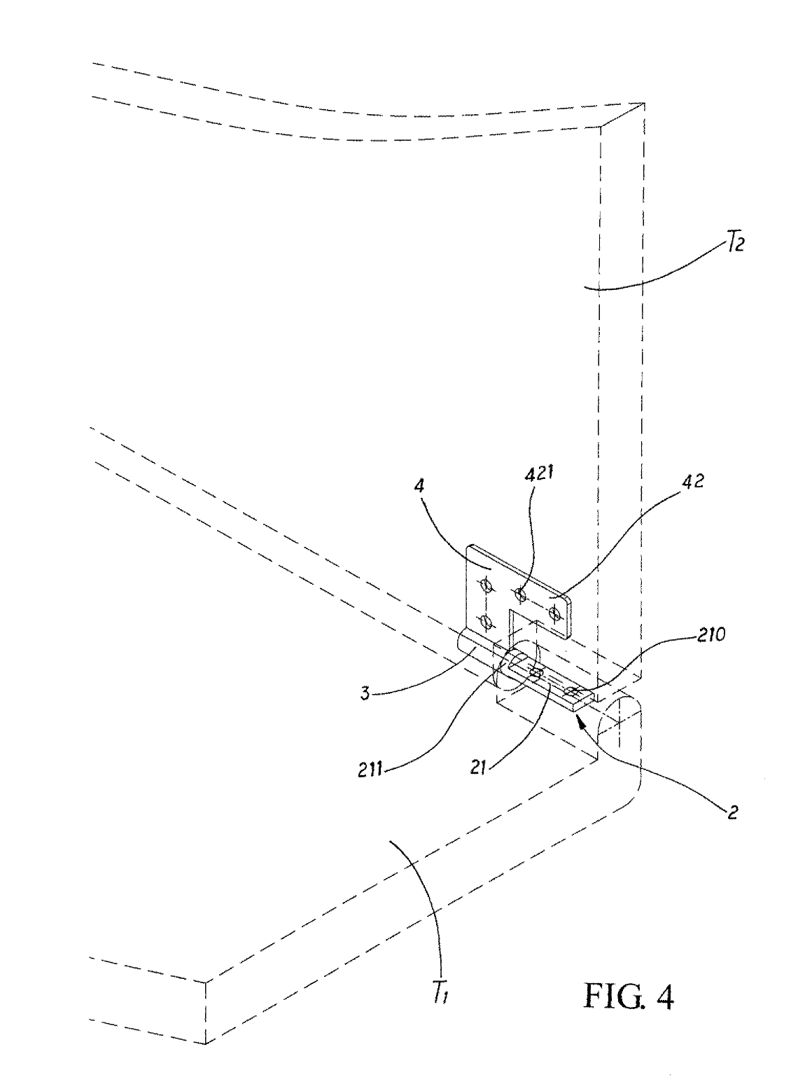

FIGS. 3 and 4 illustrate a first embodiment of the invention. The invention provides a method for manufacturing a micro-hinge pivoting two pieces of an electric device. The method includes the steps of:

a) forming a shaft 2 having a mounting end 21 and a rotating portion 22, wherein the mounting end 21 has at least one shaft hole 210 for being passed through by a fastener (not shown) to connect an object T1, and a round block 211 between the mounting end 21 and rotating portion 22, wherein a diameter of the rotating portion 22 is smaller than that of the round block 211, and the rotating portion is provided with a plurality of oil troughs 221 on its surface;

b) forming a sleeve 3 having a slot 31 and an inner diameter slightly smaller than an outer diameter of the rotating portion 22;

c) providing a connecting element 4 being an L shaped plate and having an connecting end 41 and an extending end 42, wherein the extending end 42 has at least one through hole 421 for being passed through by the fastener to connect the other object T2;

d) combining the connecting end 41 of the connecting element 4 and sleeve 3 to become integrated; and

e) inserting the rotating portion 22 into the sleeve 3 to form a hinge with damping.

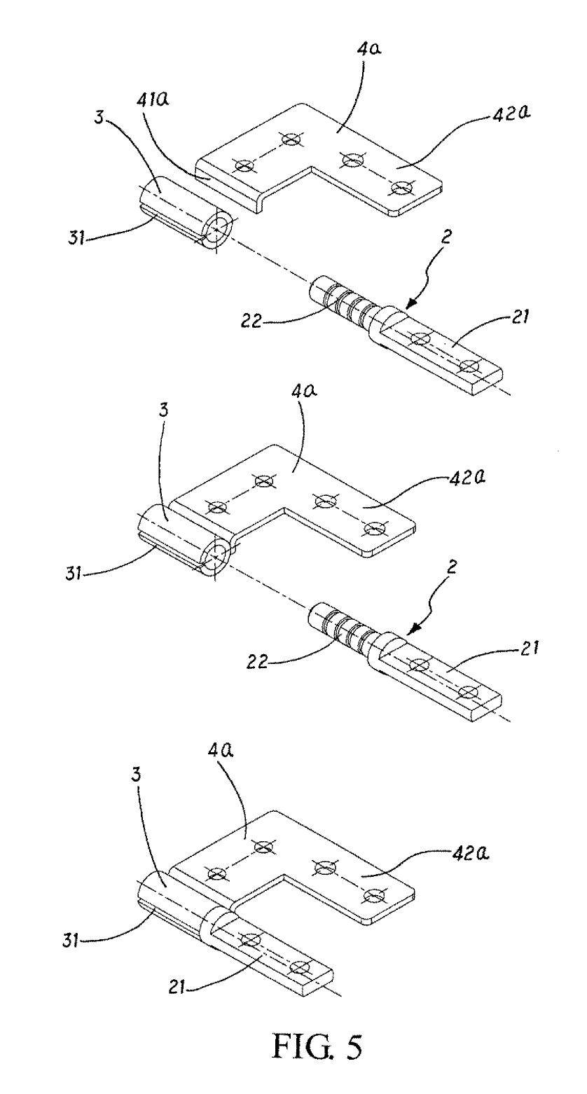

FIG. 5 illustrates a second embodiment of the invention. The shaft 2 and sleeve 3 are substantially the same as those of the first embodiment. The difference is that the connecting element 4a is provided with a bending segment 41a extending from the connecting end. The connecting end and extending end 42a integratedly form an L shaped plate. The bending segment 41a is connected with the sleeve 3 by soldering.

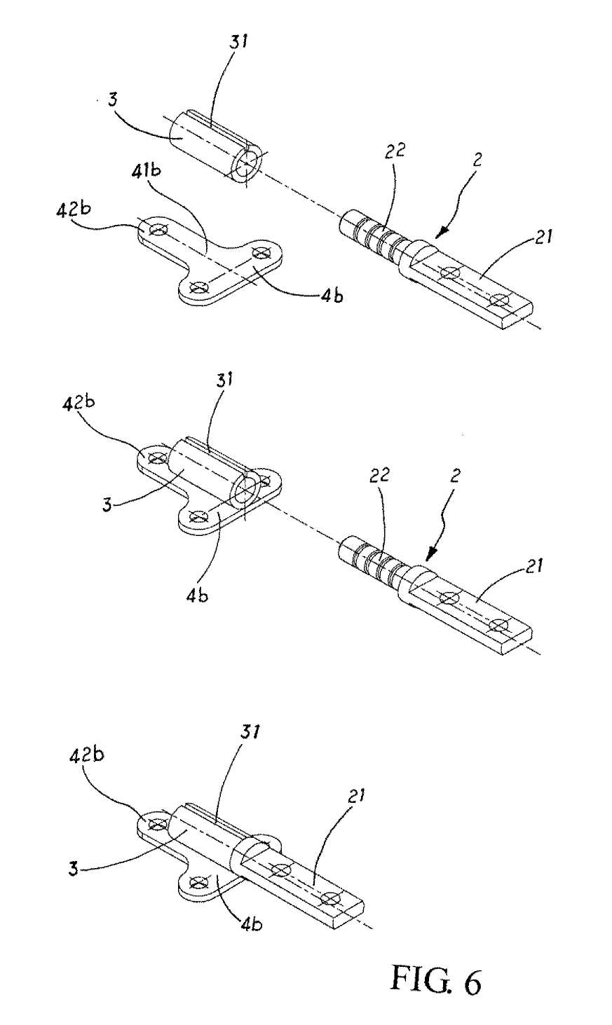

FIG. 6 illustrates a third embodiment of the invention. In this embodiment, the connecting element 4b is formed into a T shaped plate having a connecting end 41b for connecting the sleeve 3 and an extending end 42b. The sleeve 3 is fixed on the connecting end of the connecting element 4b by soldering.

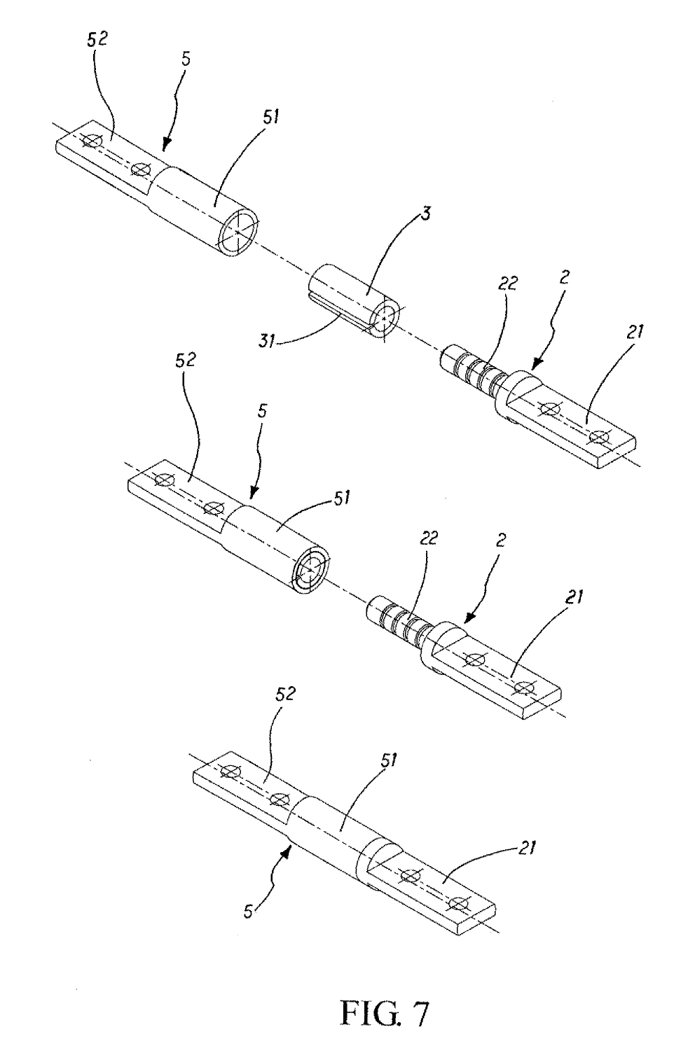

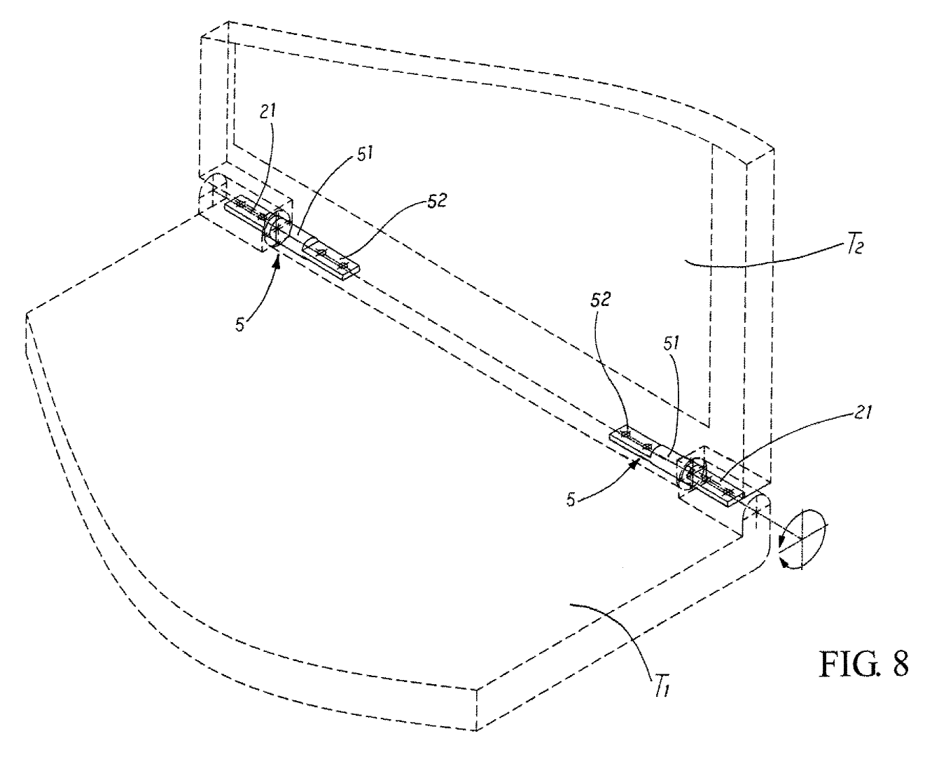

FIG. 7 illustrates a fourth embodiment of the invention. In this embodiment, the connecting element 5 has a tubular connecting end 51 and an extending end 52. The tubular connecting end 51 tightly sheathes the sleeve 3. The rotating portion 22 is inserted into the sleeve 3 to form a hinge with damping. As shown in FIG. 8, the mounting end 21 of the shaft 2 and the extending end 52 of the connecting element 5 are fixed at the objects T1 and T2, respectively. Therefore, the two objects T1 and T2 can be rotated to open or close.

What is claimed is:

1. A method for manufacturing a micro-hinge pivoting two pieces of an electric device, comprising the steps of:
a) forming a shaft having a mounting end and a rotating portion, and a round block between the mounting end and rotating portion, wherein a diameter of the rotating portion is smaller than that of the round block, and the rotating portion is provided with a plurality of oil troughs on surface thereof;
b) forming a sleeve having a slot and an inner diameter slightly smaller than an outer diameter of the rotating portion;
c) providing a connecting element having an connecting end and an extending end;
d) combining the connecting end of the connecting element and sleeve 3 to become integrated; and
e) inserting the rotating portion into the sleeve to form a hinge with damping.

2. The method of claim 1, wherein the connecting element is an L shaped plate.

3. The method of claim 1, wherein the connecting element is a T shaped plate.

4. The method of claim 2, wherein the connecting element is provided with a bending segment for connecting with the sleeve.

5. The method of claim 3, wherein connecting end of the connecting element is of a tubular shape sheathing the sleeve.

6. The method of claim 1, wherein the mounting end of the shaft has at least one shaft hole.

7. The method of claim 1, wherein the extending end of the connecting element has at least one through hole.
